(19) United States
(12) Patent Application Publication
(10) Pub. No.: US 2026/0131274 A1
(43) Pub. Date: May 14, 2026

(54) MODULES FOR RETAINING LOOSE SOLID SORBENT

(71) Applicant: Mosaic Materials, Inc., Alameda, CA (US)

(72) Inventors: Paul Cody, Houston, TX (US); Samuel Cheng, Katy, TX (US); Dustin Kraft, Houston, TX (US); Steven Russell, The Woodlands, TX (US)

(21) Appl. No.: 18/946,441

(22) Filed: Nov. 13, 2024

(51) Int. Cl. B01D 53/04

(52) U.S. Cl. CPC B01D 53/0407; B01D 2259/40088

(57) ABSTRACT

A device for retaining a solid sorbent includes a frame having a first rigid frame portion and a second rigid frame portion, and a non-rigid and porous structure forming one or more walls of a sorbent compartment having a selected shape, the sorbent compartment defining a volume for retaining the loose solid sorbent. The porous structure includes a first end attached to the first rigid frame portion and the porous structure is held in tension, the tension causing the porous structure to retain the selected shape when the loose solid sorbent is held in the sorbent compartment. The porous structure is held in tension by attachment to the first rigid frame portion and attachment to the second rigid frame portion, and/or by attachment to the first rigid portion and a weight of the loose solid sorbent.

### BACKGROUND

In the resource recovery and fluid sequestration industries, as well as other industries, sorbents are used to remove gases, vapors, and other components from fluids (e.g., flue gas or direct air capture) via adsorption. For example, adsorption systems such as carbon capture systems may capture carbon dioxide via adsorption with sorbents. The sorbents may then be fed to a desorption system to remove desired components.

### SUMMARY

An embodiment of a device for retaining a solid sorbent includes a frame having a first rigid frame portion and a second rigid frame portion, and a non-rigid and porous structure forming one or more walls of a sorbent compartment having a selected shape, the sorbent compartment defining a volume for retaining the loose solid sorbent. The porous structure includes a first end attached to the first rigid frame portion and the porous structure is held in tension, the tension causing the porous structure to retain the selected shape when the loose solid sorbent is held in the sorbent compartment. The porous structure is held in tension by attachment to the first rigid frame portion and attachment to the second rigid frame portion, and/or by attachment to the first rigid portion and a weight of the loose solid sorbent.

An embodiment of a method includes introducing a loose solid sorbent to an interior of a sorbent compartment of a device, the device configured as at least one of a desorption device and an adsorption device, the device including a frame having a first rigid frame portion and a second rigid frame portion, and a non-rigid and porous structure forming one or more walls of the sorbent compartment, the sorbent compartment defining a volume for retaining the loose solid sorbent. The porous structure includes a first end attached to the first rigid frame portion and the porous structure is held in tension, the tension causing the porous structure to retain a selected shape when the loose solid sorbent is held in the sorbent compartment., wherein the porous structure is held in tension by at least one of: attachment to the first rigid frame portion and attachment to the second rigid frame portion, and attachment to the first rigid portion and a weight of the loose solid sorbent; and at least one of: flowing air through the sorbent compartment, the loose solid sorbent adsorbing a material from the air; and applying thermal energy to the sorbent compartment to cause a heat exchange process between the solid sorbent and the thermal energy source to remove the adsorbed material from the loose solid sorbent.

### BRIEF DESCRIPTION OF THE DRAWINGS

The following descriptions should not be considered limiting in any way. With reference to the accompanying drawings, like elements are numbered alike:

FIG. 1 schematically depicts an embodiment of a direct air capture system used to remove carbon from a fluid or gas;

FIGS. 2A-2B depict embodiments of a sorbent module having a rigid frame and a set of sorbent compartments made from a porous and flexible material;

FIGS. 3A-3B depict embodiments of a sorbent module having a rigid frame and a set of sorbent compartments configured as insertable sleeves;

FIG. 4 depicts an embodiment of a sorbent module having a rigid frame and a set of cylindrical sleeves made from a porous and flexible material;

FIG. 5 depicts an embodiment in which the sorbent module is disposed in a vessel, such as a heat exchange and/or desorption vessel; and

FIGS. 6A-6B depict examples of a sorbent module having at least one tensioning device.

### DETAILED DESCRIPTION

A detailed description of one or more embodiments of the disclosed apparatus and method are presented herein by way of exemplification and not limitation with reference to the Figures.

Devices, systems and methods for adsorption, heat exchange and/or desorption are provided herein (e.g., as part of a direct air capture system). Embodiments include one or more modules (referred to as “sorbent modules”) for retaining a loose solid sorbent, such as a solid sorbent used for capturing carbon dioxide. An embodiment of a sorbent module includes a rigid frame or support structure and a porous flexible structure (e.g., a bag, a series of flexible panels, a tube, etc.) that defines at least part of a porous compartment, passageway or chamber for holding loose solid sorbent. The porous flexible structure is held in tension by the support structure, so that the porous compartment, passageway or chamber maintains it shape and retains loose solid sorbent without significant deformation. The porous flexible structure allows air and other gases through (e.g., air, desorbed gases) but does not allow the solid sorbent to pass through.

The sorbent modules described herein may be used in conjunction with one or more components or stages of a direct air capture system, in which a bulk solid medium in loose form (e.g., as pellets) is used in a direct air carbon capture process. The direct air carbon capture process may be a stationary or moving bed process. For example, the loose solid sorbent may move through a system as a bulk medium, packaged in cartridges that are moved, or may remain stationary in a cartridge for all processes of the direct air capture system. The direct air capture system includes various stages, which include adsorption and desorption stages, and may include one or more intermediary conditioning steps.

In the adsorption stage, loose solid sorbent is moved into an adsorption configuration, which may be an array of filter structures in a chamber or chambers (referred to as “adsorption chambers”), whereby air is moved across the sorbent for the purposes of capturing carbon dioxide until a predetermined saturation point. In an embodiment, one or more of the filter structures is a sorbent module as described herein. At the predetermined saturation point, saturated sorbent is moved from the adsorption stage and into a desorption stage.

A desorption stage may include a desorption vessel that uses thermal energy (e.g., conduction, convection, electromagnetic energy, and/or induction) to remove adsorbed material, such as captured water and CO2 is desorbed from the loose solid sorbent. In an embodiment, the desorption vessel includes one or more sorbent modules. Desorption may be performed under atmospheric pressure or under a vacuum.

Once a desorption stage is complete, the loose solid sorbent may be moved back into the adsorption stage (as regenerated bulk solid such as MOF) to complete the process loop. An intermediate cooling stage that includes heat recovery may be included in the process. During the process, fines generated may be collected and more bulk solid may be periodically or continuously added to account for any attrition during the process. The process may be continuous or include several discrete batch processes.

Embodiments described herein present a number of advantages. The embodiments allow for construction of modules used for adsorption and/or desorption with less mass and cost than existing systems. For example, the use of non-rigid or flexible structures held in tension as described herein allows for eliminating frame portions (e.g., rigid frame portions at two or more sides) that are used in current packages for retaining solid sorbent, while maintaining structural integrity.

In existing direct air capture systems, loose solid sorbent is retained in a rigid package having an external frame and rigid perforated plates to achieve a desired bed thickness and array of sorbent beds for air flow. For example, existing packages use a fully connected four-sided rigid frame and a relatively thick perforated plate. Such packages require a significant amount of material (e.g., aluminum, steel, etc.). Embodiments significantly reduce the amount of mass required to arrange sorbent media by replacing perforated plates with non-rigid or flexible retaining structures (e.g., bags, sheets or sleeves). Such structures result in the sorbent modules described herein having much less mass than the typical rigid packages. In addition, the sorbent modules are configured to at least substantially retain their shape by tension, and without any internal ties or other internal retaining devices; in this way, mass is reduced and the volume of the module (i.e., volume in which the loose sorbent is retained) is maximized. An “internal retaining device” is a device that is disposed within a volume defined by the flexible structure(s) or a device that engages the flexible structure(s) between flexible structures within a frame or housing. Embodiments also allow for periodic tightening (or as otherwise needed) to maintain tension and a shape of the flexible structure(s).

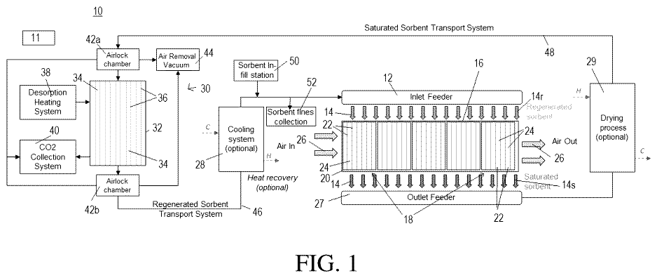

FIG. 1 depicts an embodiment of a carbon capture system 10 for removing carbon dioxide from air using direct air capture. The system 10 utilizes a solid sorbent that is exposed to air and adsorbs carbon dioxide. In an embodiment, the solid sorbent is a loose solid sorbent, such as pellets or granules.

Referring to FIG. 1, in an embodiment, the system 10 is configured as a moving sorbent system in which a solid sorbent 14 moves in a continuous flow or in small discrete batches through the adsorption and desorption processes. However, embodiments described herein are not limited to this specific configuration or to a moving bed configuration. For example, embodiments may be applicable to stationary systems (in which solid sorbent remains stationary during adsorption and/or desorption).

The system 10 includes a feeder 12, such as a hopper or drop spreader, which receives a supply of a loose solid sorbent 14 that is packaged as a bulk solvent (e.g., pellets or granules), or is otherwise configured so that the solid sorbent 14 can be moved through the system 10. For example, the solid sorbent 14 is a metal organic framework (MOF), but is not so limited. Other examples of solid sorbents include activated carbon and zeolites.

The sorbent may be, for example, metal-organic frameworks, Zeolites, amine-impregnated porous materials, amine-functionalized porous materials, or a combination of one or more of the above. The sorbent may be another sorbent known in the art or a combination of sorbents including those known in the art.

The solid sorbent 14 (e.g., regenerated sorbent 14r) is fed via the feeder 12 to one or more adsorption chambers 16. The adsorption chamber 16 includes an array of sorbent modules configured as filter modules 18. Each filter module 18 includes a housing or frame 20 made from a rigid material, such as steel or other metal, or plastic. As described herein, a “rigid” structure is a structure that at least substantially holds its own shape without external supports.

Each filter module 18 also includes a flexible and porous structure 22, formed from, for example, sheets or a sleeve of a porous material. The porous structure 22 defines part of a porous compartment 24 for holding loose solid sorbent in place as air flows through the adsorption chamber 16. For example, each porous compartment 24 forms a rectangular volume or other volume having a desired size and shape, and bed thickness (i.e., width in the direction of airflow).

During a desorption process, air 26 flows through the adsorption chamber 16, where carbon dioxide and water molecules are adsorbed to the solid sorbent as the solid sorbent falls to an outlet feeder 27. Upon saturation with CO2 and/or water, the saturated sorbent 14s may be transferred to an optional drying process 29 for removal of at least some captured water.

The dried saturated sorbent 14s is then provided to a desorption system 30 for removal of the captured carbon dioxide. The desorption system 30 includes a feeder (not shown), such as a conical hopper, which feeds the saturated dried sorbent 14s to passageways 34 within a desorption vessel 32 (or multiple desorption vessels 32). The passageways 34 hold respective portions of the saturated sorbent 14s and may direct the sorbent in a selected direction, such as a vertical direction or direction of gravity. Each passageway 34 has a cylindrical wall 36, which may be formed by attaching a flexible porous sleeve to the vessel 32 in tension. While described as cylinders, the passageways 34 may be another shape known in the art or a combination of shapes having a desired size and shape, and bed thickness.

The saturated sorbent 14s is desorbed by applying thermal energy from a heating system 38 to the saturated sorbent 14s, and desorbed carbon dioxide gas may be removed from the vessel 32 to a collection system 40.

The desorption system may include other components and/or subsystems. For example, the desorption vessel 32 is connected to one or more airlock assemblies 42 positioned upstream and/or downstream of the vessel 32. Each airlock assembly 42 is configured to isolate an amount of sorbent (e.g., an amount of the saturated sorbent 14s) during a process in which the amount of sorbent is introduced to the desorption vessel 32, and/or during a process in which the amount of sorbent (e.g., regenerated solid sorbent 14r) is removed from the desorption vessel 32. Each airlock assembly 42 includes an airlock chamber (not shown) defined by chamber walls and a pair of airlock valves (not shown).

For example, as shown in FIG. 1, two airlock assemblies 42 are connected to the vessel 32 denoted as an input airlock assembly 42a located upstream of the vessel 32, and an output airlock assembly 42b located downstream of the vessel 24. The airlock chamber of a respective assembly can be evacuated to establish a partial vacuum (i.e. a pressure that is less than an atmospheric pressure) via a vacuum pump 44.

After desorption, regenerated solid sorbent 14r is fed to a conveyor or other mechanism (e.g., tubular conveyor, conveyor belt, bucket elevator conveyor) for return to the feeder 12. The desorption system 30 may include (or may be connected to) a cooling system 28 for recovering waste heat from the desorption process. The waste heat may be used to heat a gas or fluid used for heat exchange in the desorption system 30.

Other components or subsystems may include a transport system 48 for transporting saturated sorbent 14s to the desorption vessel 32, and a transport system 46 for transporting regenerated sorbent 14r from the desorption vessel 32 to the inlet feeder 12. Other components or subsystems may include a sorbent in-fill station 50 for adding lean sorbent to the regenerated sorbent 14r to account for losses due to attrition into fines (i.e., sorbent particles that are too small to be re-used), and/or a sorbent fines collection station 52.

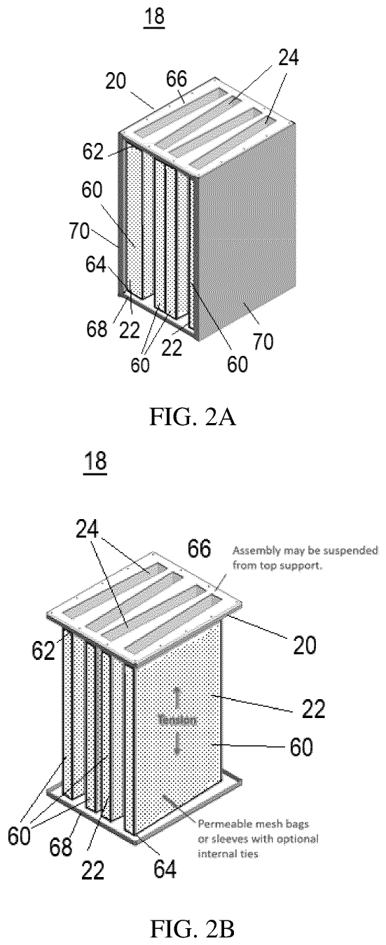

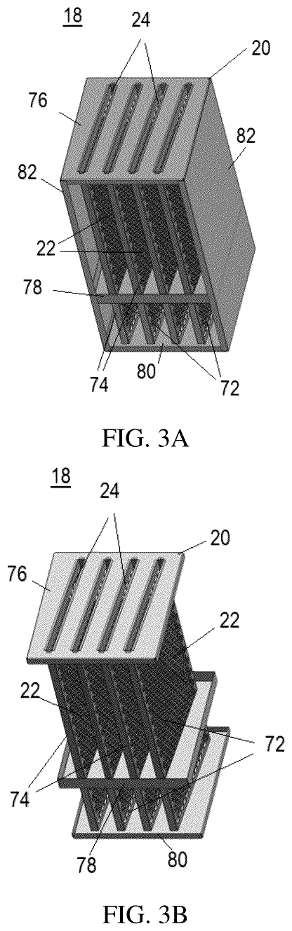

FIGS. 2A-2B and 3A-3B depict embodiments of the filter module 18. The filter module 18 includes one or more porous compartments 24 having a volume defined, at least in part, by the non-rigid porous structure 22. The porous compartments 24 may be configured to be disposed in the adsorption chamber 16 (e.g., as a single module or multiple modules arrayed together). It is noted that the filter module 18 is not limited to any particular adsorption system. In addition, the filter module 18 is not limited to the specific size, shape or structure described herein.

The filter module 18 includes a rigid frame 20, such as a stainless steel or aluminum frame. The non-rigid and porous structure 22 forms at least one wall of each porous compartment 24, and is configured to prevent solid sorbent from passing therethrough, while allowing gases (e.g., air, oxygen, carbon dioxide, etc.) to pass therethrough. In this way, the filter module 18 allows air to be flowed through the filter module 18 and interact with loose solid sorbent retained therein.

The porous structure is non-rigid, i.e., is flexible or conformable. For example, each porous structure 22 is a sheet formed from a plastic or metal mesh, or thin perforated sheets. The thin sheets have a thickness such that the sheet is flexible (i.e., will deform due to the weight of sorbent if no other components are used to support the sheet). In an embodiment, the porous structure 22 is a thin perforated metal sheet having a thickness that is less than ⅛^{th} of an inch (e.g., 1/16^{th} of an inch or less). To provide rigidity and structural integrity of the porous compartments 24, the porous structures are held in tension by the frame 20. In an embodiment, the porous structure is formed from a mesh sheet or other mesh structure, in combination with a thin perforated sheet.

FIGS. 2A-2B show examples of the filter module 18, in which each porous structure 22 is formed as a mesh pouch, sleeve or bag. In these examples, the porous structure is a mesh sleeve 60. For example, the sleeve 60 is formed by interweaved metallic or plastic fibers or wires. It is noted that, although the sleeve 60 is discussed as having a mesh structure, the sleeve 60 may have any suitable porous configuration.

The frame 20 includes a first frame portion and a second frame portion, and each mesh sleeve 60 has a first end 62 attached to the first frame portion and a second end 64 attached to the second frame portion (while the mesh sleeve 60 is in tension).

For example, the frame 20 includes at least a top portion 66 configured as a flat plate having rectangular openings (or other shaped openings, such as circular, oval, square, etc.). The frame 20 also includes at least a bottom portion 68 that opposes the top portion 60. The bottom portion 68 may include openings similar to the top openings, or may be continuous.

Each mesh sleeve 60 is attached to the top portion 66 and the bottom portion 68, and is held in tension, so that the mesh sleeve 60 substantially holds its shape and retains loose solid sorbent in a stationary position. Each mesh sleeve 60 may be attached to a periphery of an opening, such as by an adhesive, weld, clamp, groove, or mechanical fasteners.

Each mesh sleeve 60 is also attached to the bottom portion 68, such that the side walls of the mesh sleeve 60 are held vertically in tension and hold a planar shape when solid sorbent is added. The bottom of the mesh sleeve 60 may be attached directly to the bottom portion 68, or the mesh sleeve 60 is suspended from the top portion 68 and tied to the bottom portion 68.

It is noted that the bottom of the mesh sleeve 60 may be open (e.g., to allow sorbent to fall through). Alternatively, the bottom of the mesh sleeve 60 is closed, thereby forming a pouch or bag that can hold the sorbent in place.

FIG. 2A shows the filter module 18 having a series of mesh sleeves 60, forming a series of porous compartments having sides (and optionally a bottom surface) formed by tensioned porous walls. In this example, the filter module 18 includes outer structures 70, which may be formed from a rigid material and form part of the structural support of the module 18 and the mesh sleeves 60, or may be made from porous flexible outer sheets. The porous flexible outer sheets may act as an inlet filter for incoming air flow, which then flows through each mesh sleeve 60 and associated sorbent bed.

FIG. 2B shows the filter module 18 without the outer structures 70. This example may be used, for example, as one of an array of modules that are positioned in the adsorption chamber 16 or other adsorption system.

FIGS. 3A and 3B show examples in which each compartment 24 is defined by a rectangular sleeve 72. The sleeve 72 is not limited and may have any suitable planar or non-planar shape, such as square, triangular, tapered or any other suitable shape known to those skilled in the art. The rectangular sleeve 72 has side walls formed from the porous structures 22, and has a desired width or bed thickness. The porous structures 22 in these examples may be mesh sheets or thin perforated sheets, or each porous structure includes both a mesh sheet and a thin perforated sheet.

Each sleeve 72 includes or is coupled to a sleeve frame that provides support to the porous structures 22. The porous structures 22 may be attached to the sleeve frame in tension (e.g., by tensioning each sheet and attaching each sheet to the frame while the sheet is in tension), to provide structural integrity and allow the sleeve 72 to maintain its shape. An example of a sleeve frame includes one or more portions of the frame 20. A solid divider plate 74 may be positioned in front of each sleeve 72 to route airflow through the solid sorbent and to an air outlet or exhaust.

In these examples, the frame 20 includes a top portion 76 that defines rectangular openings. Each sleeve 72, in an embodiment, is not attached to the frame 20, but is insertable and removable (e.g., to allow for easy replacement) and held in position by the top portion 76 and an optional intermediate support plate 78. Alternatively, a sleeve frame may be excluded, and the porous structures 22 (e.g., mesh sheets) are attached to the top portion 76 and a bottom portion 80, and held in tension.

FIG. 3A shows the filter module 18 having an outer structure 82, which may be formed from a porous or non-porous rigid material and form part of the structural support of the module 18, or may be made from porous or non-porous flexible outer sheets. FIG. 3B shows the filter module 18 without the outer structures 82.

The non-rigid and porous structure may form a planar wall of a sorbent module, or a non-planar wall. For example, the porous structure includes at least one planar sheet forming a planar wall of the sorbent compartment, such as that shown in the examples of FIGS. 1, 2A, 2B, 3A and 3B.

In an embodiment, the porous structure of a sorbent module has a non-planar wall defined by at least one non-planar sheet, which is made from a porous and flexible material. In this embodiment, the sorbent module defines one or more compartments having a non-planar shape (i.e., a shape having at least one non-planar surface). The non-planar sheet(s) is/are held in tension so that each non-planar sheet functions as a substantially rigid wall. Examples of non-planar shapes include cylinders or partial cylinders, ovular shapes, pouch shapes, etc.

For example, referring again to FIG. 1, the passageways 34 are formed from cylindrical sleeves made from a porous and flexible material, such as a plastic or metal mesh. The plastic or metal mesh forms a cylindrical wall 34 of a sleeve. The sleeves are held in tension via attachment to the vessel 32 (or other structure attached to the vessel 32), such that the sleeve walls become rigid as a result of the tension and retain the cylindrical shape when loose solid sorbent is fed into the passageways.

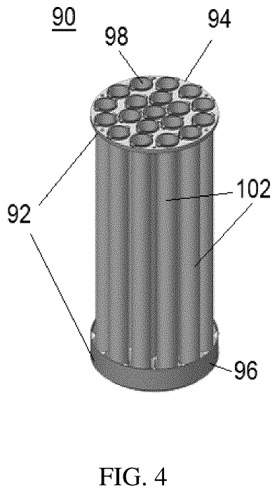

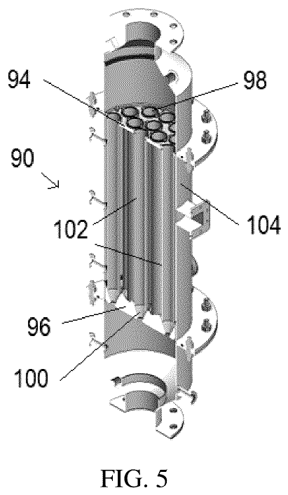

In an embodiment, the porous structure forms a wall of a sorbent compartment. The sorbent compartment may be cylindrical as shown, or form any other cross-section shape (planar or non-planar). FIGS. 4 and 5 show examples of a device or sorbent module 90 configured to retain loose solid sorbent.

The sorbent module 90 includes a frame 92 having an upper frame portion 94 and a lower frame portion 96. The upper frame portion 94 includes a set of circular openings 98. The lower frame portion 96 also includes a set of openings 100.

A set of sorbent passageways are defined by flexible and porous sleeves 102 made from, for example, a metal mesh. The sleeves 102 may be made from a metal or other thermally conductive material to facilitate heat exchange. Each sleeve 102 is attached at a respective end to an opening 98 and an opening 100 and held in tension so that each sleeve 92 maintains its cylindrical shape as loose solid sorbent is introduced.

Alternatively, each sleeve 102 is attached only to an opening 98 and tension is applied and maintained by the weight of the solid sorbent held therein. For example, the tension is created by the friction and bridging of the solid sorbent to the wall of the sleeve 102, rather than from an external support structure.

The sorbent module 90, in an embodiment, is disposed in a structure configured to allow air and/or thermal energy to interact with the loose solid sorbent. For example, as shown in FIG. 5, the sorbent module 90 can be part of an adsorption device, which includes a housing or vessel 104. The vessel 104 encloses the sorbent module 90, and may be used for adsorption by flowing air therethrough, or desorption by applying thermal energy to loose saturated sorbent.

In an embodiment, the vessel 104 is a heat exchange and/or desorption vessel that is part of a desorption system (e.g., the desorption system 30 of FIG. 1). In this embodiment, each porous sleeve 102 defines a passageway or volume (e.g., a passageway 36 of FIG. 1), and may be made from a thermally conductive material, such as steel, aluminum or other metal. The porous structure may be formed from sheets or cylinders of a metal mesh or thin perforated metal. The thin perforated metal has a thickness that is less than a thickness of a typical heat exchanger tube, such as a thickness that is less than ⅛^{th} of an inch (e.g., 1/16^{th} of an inch or less). Such thicknesses may also be applicable to perforated sheets used to form planar sorbent compartments, as noted above.

The desorption system may be the desorption system 30 of FIG. 1 (in which the vessel 104 is the vessel 32), but is not so limited. The desorption system can use various types of energy to heat solid sorbent (including any combination of types of energy). For example, heat exchange is performed via conduction and/or convection using a heat exchange fluid (e.g., CO2), electromagnetic energy (e.g., RF energy such as microwaves), electromagnetic induction or any combination thereof.

For example, the desorption system is configured for convective and/or conduction heating using a heat exchange fluid, and the porous sleeves 102 define a plurality of passageways that allow a loose solid sorbent to move through the vessel 104 (e.g., by gravity), or otherwise retain the solid sorbent. The sleeves 102 may be made from a porous, flexible and thermally conductive material (e.g., aluminum, steel, copper, ceramic, etc.) or other material having varying levels of thermal conductivity (e.g., plastic, ceramic, etc.).

Each sleeve 102 extends vertically and is attached to an internal frame of the vessel 104, and held in tension. Each sleeve 102 forms part of a heat exchanger, and has a size or diameter selected to allow solid sorbent pellets or granules to be retained during heat exchange and desorption, and subsequently fall vertically through the heat exchanger to a collector (not shown). The collector may be connected to a mechanism (e.g., the transport system 46 of FIG. 1) to return the solid sorbent 14 for re-use in carbon capture, or otherwise to transport the solid sorbent to a desired location or system.

Each sleeve 102 is held in tension so that the cylindrical shape of each sleeve 102 is retained when loose solid sorbent is retained therein. Solid sorbent cannot pass through the sleeve 102, but heat exchange fluid can pass through and interact directly with the solid sorbent. Each sleeve 102 also allows desorbed gas and water vapor to pass through the sleeve to facilitate removal of the desorbed gas from the vessel 104.

In this example, loose solid sorbent is introduced and moves downward by gravity, and the heat exchange fluid (e.g., heated CO2 gas having a temperature greater than a temperature of the solid sorbent) enters the vessel 104 and flows through the vessel 104. Desorbed gases combine into the heat exchange fluid stream and are evacuated through a recirculation loop to equalize system pressure. For example, a slight vacuum is used to draw some of the CO2 gas for collection, sequestration and/or storage. Regenerated sorbent exits the bottom of the collector and may be re-used.

Other forms of thermal energy may be applied to heat the solid sorbent. For example, the solid sorbent is heated using electromagnetic or RF radiation, such as microwaves. In another example, the solid sorbent is heated using electromagnetic energy via induction (e.g., via a series of induction coils surrounding each sleeve 102, which are connected to a power source). An alternating current may be applied to the induction coils to heat the sleeves 102 and thereby heat the solid sorbent within the sleeves 102. Alternatively, the solid sorbent may be heated directly by induction. Carbon dioxide gas, or other convection fluid, may be directed into the vessel 104 to ensure even heat distribution and/or to provide additional heat.

In an embodiment, a porous structure (e.g., the porous structure 22, the passageway 34 and/or the sleeve 102) is held in tension, which is adjustable using one or more tensioning devices. Examples of tensioning devices include spring-based devices, hydraulic tensioners, screw tensioners and others.

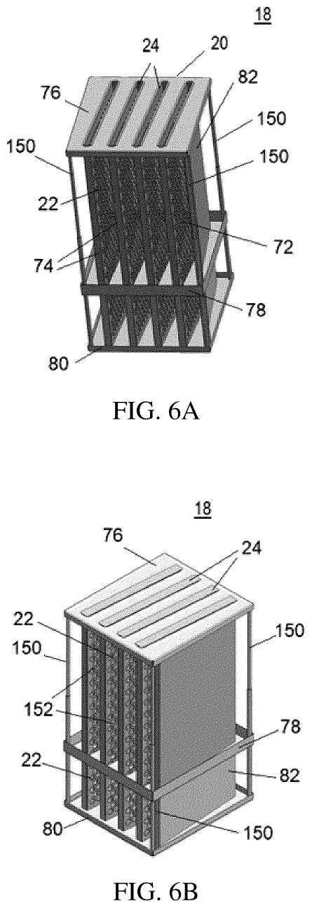

FIGS. 6A and 6B show embodiments of the filter module 18, which include an example of a tensioning device 150. It is noted that a tensioning device 150 may be employed in conjunction with any of the embodiments described herein.

In the example of FIG. 6A, the porous structures 22 are sleeves 72 supported by sleeve frames. In the example of FIG. 6B, the porous structures 22 are thin perforated sheets 152.

The filter module 18 includes at least one tensioning device 150 in the form of a telescoping tensioning rod 150 that extends from the top portion 76 to the bottom portion 80. In these examples, a tensioning rod 150 is positioned at or near a respective corner of the rigid frame 20. The filter module 18 is not so limited, as any number of tensioning devices 150 may be positioned at any suitable location.

Each tensioning device 150 may be operable manually or by a controller (e.g., the controller 11 of FIG. 1) to adjust an amount of tension and maintain the shape of the porous structures 22. The tensioning rods 150 may be extended to increase the tension of the porous structures 22, for example, to compensate for sagging or deformation of the porous structures. Generally, the tensioning rods 150 are operated as needed or desired to ensure that a sufficient amount of tension is being applied to maintain the shape of each porous structure 22.

In an embodiment, the system 10, the desorption system 30 and/or the desorption system 100 includes a control device or system (such as a controller 11 shown in FIG. 1) configured to control operation of one or more components therein. The controller 11 may be configured to perform aspects of a method of carbon capture, desorption and collection as described herein.

The controller 11 includes one or more processors, and may include components such as an input/output device, and a data storage device (e.g., memory, computer-readable media, etc.) for storing data, models and/or computer programs or software that cause the one or more processors to perform aspects of methods and processes described herein. An example of the controller 11 is shown in FIG. 1, which is connected to components of the system 10 and controls, for example, airflow, movement of solid sorbent, airlocks, etc. The controller 11 may control any of the components and systems described herein.

Set forth below are some embodiments of the foregoing disclosure:

Embodiment 1: A device for retaining a solid sorbent, comprising: a frame having a first rigid frame portion and a second rigid frame portion; and a non-rigid and porous structure forming one or more walls of a sorbent compartment having a selected shape, the sorbent compartment defining a volume for retaining the loose solid sorbent, wherein the porous structure includes a first end attached to the first rigid frame portion and the porous structure is held in tension, the tension causing the porous structure to retain the selected shape when the loose solid sorbent is held in the sorbent compartment, wherein the porous structure is held in tension by at least one of: attachment to the first rigid frame portion and attachment to the second rigid frame portion; and attachment to the first rigid portion and a weight of the loose solid sorbent.

Embodiment 2: The device of any prior embodiment, wherein the porous structure is a flexible sheet forming a planar or non-planar wall of the sorbent compartment.

Embodiment 3: The device of any prior embodiment, wherein the flexible sheet is a mesh or a perforated sheet of a flexible material, or a perforated sheet having a thickness selected to minimize a mass of the perforated sheet so that the perforation sheet is caused to be flexible, the thickness selected to cause the perforated sheet to have a tensile capacity sufficient to hold the loose solid sorbent while retaining the selected shape.

Embodiment 4: The device of any prior embodiment, further comprising a tensioning device configured to engage at least one of the first rigid frame portion and the second rigid frame portion, the tensioning device operable to adjust a magnitude of the tension.

Embodiment 5: The device of any prior embodiment, wherein the first frame and the second frame portion hold the porous structure in tension to form a stiff wall that holds the shape of the sorbent compartment without any additional components, the additional components including a component internal to the sorbent compartment, a component between multiple sorbent compartments, and a component directly attached to the porous structure between the first frame portion and the second frame portion.

Embodiment 6: The device of any prior embodiment, wherein the porous structure is formed as a porous sheet defining a wall of the compartment, the porous sheet forming a surface orthogonal to a direction of airflow through the device.

Embodiment 7: The device of any prior embodiment, wherein the porous structure is a sleeve having an opening attached to the first frame portion, and an end attached to the second frame portion to hold the sleeve in tension.

Embodiment 8: The device of any prior embodiment, wherein the device is configured as a sorbent module for retaining the loose solid sorbent in at least one of an adsorption system and a desorption system.

Embodiment 9: The device of any prior embodiment, wherein the porous structure is a flexible sleeve forming a wall of the sorbent compartment.

Embodiment 10: The device of any prior embodiment, wherein the porous structure is a cylinder.

Embodiment 11: The device of any prior embodiment, wherein the tension is a result of a friction and bridging load from the weight of the loose solid sorbent acting upon an internal surface of the porous structure.

Embodiment 12: The device of any prior embodiment, wherein the porous structure is part of a desorption vessel, and the cylinder forms part of a heat exchanger configured to retain the loose solid sorbent and permit the loose solid sorbent to be heated by a source of thermal energy.

Embodiment 13: A method comprising: introducing a loose solid sorbent to an interior of a sorbent compartment of a device, the device configured as at least one of a desorption device and an adsorption device, the device including a frame having a first rigid frame portion and a second rigid frame portion, and a non-rigid and porous structure forming one or more walls of the sorbent compartment, the sorbent compartment defining a volume for retaining the loose solid sorbent, wherein the porous structure includes a first end attached to the first rigid frame portion and the porous structure is held in tension, the tension causing the porous structure to retain a selected shape when the loose solid sorbent is held in the sorbent compartment, wherein the porous structure is held in tension by at least one of: attachment to the first rigid frame portion and attachment to the second rigid frame portion, and attachment to the first rigid portion and a weight of the loose solid sorbent; and at least one of: flowing air through the sorbent compartment, the loose solid sorbent adsorbing a material from the air; and applying thermal energy to the sorbent compartment to cause a heat exchange process between the solid sorbent and the thermal energy source to remove the adsorbed material from the loose solid sorbent.

Embodiment 14: The method of any prior embodiment, wherein the flexible sheet is a mesh or a perforated sheet of a flexible material, or a perforated sheet having a thickness selected so that the perforation sheet is caused to be flexible.

Embodiment 15: The method of any prior embodiment, further comprising adjusting an amount of the tension by a tensioning device configured to engage at least one of the first rigid frame portion and the second rigid frame portion.

Embodiment 16: The method of any prior embodiment, wherein the first rigid frame portion and the second rigid frame portion hold the porous structure in tension to form a stiff wall that holds the shape of the sorbent compartment without any additional components, the additional components including a component internal to the sorbent compartment, a component between multiple sorbent compartments, and a component attached to the porous structure between the first frame portion and the second frame portion.

Embodiment 17: The method of any prior embodiment, wherein the porous structure is formed as a porous sheet defining a wall of the compartment, the porous sheet forming a surface orthogonal to a direction of airflow through the device.

Embodiment 18: The method of any prior embodiment, wherein the porous structure is a sleeve having an opening attached to the first rigid frame portion, and an end attached to the second rigid frame portion to hold the sleeve in tension.

Embodiment 19: The method of any prior embodiment, wherein the end attached to the second rigid frame portion is open.

Embodiment 20: The method of any prior embodiment, wherein the porous structure is a flexible sleeve forming a wall of the sorbent compartment.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A device for retaining a solid sorbent, comprising:
a frame having a first rigid frame portion and a second rigid frame portion; and
a non-rigid and porous structure forming one or more walls of a sorbent compartment having a selected shape, the sorbent compartment defining a volume for retaining the loose solid sorbent, wherein the porous structure includes a first end attached to the first rigid frame portion and the porous structure is held in tension, the tension causing the porous structure to retain the selected shape when the loose solid sorbent is held in the sorbent compartment, wherein the porous structure is held in tension by at least one of:
attachment to the first rigid frame portion and attachment to the second rigid frame portion; and
attachment to the first rigid portion and a weight of the loose solid sorbent.

2. The device of claim 1, wherein the porous structure is a flexible sheet forming a planar or non-planar wall of the sorbent compartment.

3. The device of claim 2, wherein the flexible sheet is a mesh or a perforated sheet of a flexible material, or a perforated sheet having a thickness selected to minimize a mass of the perforated sheet so that the perforation sheet is caused to be flexible, the thickness selected to cause the perforated sheet to have a tensile capacity sufficient to hold the loose solid sorbent while retaining the selected shape.

4. The device of claim 1, further comprising a tensioning device configured to engage at least one of the first rigid frame portion and the second rigid frame portion, the tensioning device operable to adjust a magnitude of the tension.

5. The device of claim 1, wherein the first frame and the second frame portion hold the porous structure in tension to form a stiff wall that holds the shape of the sorbent compartment without any additional components, the additional components including a component internal to the sorbent compartment, a component between multiple sorbent compartments, and a component directly attached to the porous structure between the first frame portion and the second frame portion.

6. The device of claim 5, wherein the porous structure is formed as a porous sheet defining a wall of the compartment, the porous sheet forming a surface orthogonal to a direction of airflow through the device.

7. The device of claim 5, wherein the porous structure is a sleeve having an opening attached to the first frame portion, and an end attached to the second frame portion to hold the sleeve in tension.

8. The device of claim 1, wherein the device is configured as a sorbent module for retaining the loose solid sorbent in at least one of an adsorption system and a desorption system.

9. The device of claim 1, wherein the porous structure is a flexible sleeve forming a wall of the sorbent compartment.

10. The device of claim 1, wherein the porous structure is a cylinder.

11. The device of claim 10, wherein the tension is a result of a friction and bridging load from the weight of the loose solid sorbent acting upon an internal surface of the porous structure.

12. The device of claim 10, wherein the porous structure is part of a desorption vessel, and the cylinder forms part of a heat exchanger configured to retain the loose solid sorbent and permit the loose solid sorbent to be heated by a source of thermal energy.

13. A method comprising:
introducing a loose solid sorbent to an interior of a sorbent compartment of a device, the device configured as at least one of a desorption device and an adsorption device, the device including a frame having a first rigid frame portion and a second rigid frame portion, and a non-rigid and porous structure forming one or more walls of the sorbent compartment, the sorbent compartment defining a volume for retaining the loose solid sorbent, wherein the porous structure includes a first end attached to the first rigid frame portion and the porous structure is held in tension, the tension causing the porous structure to retain a selected shape when the loose solid sorbent is held in the sorbent compartment, wherein the porous structure is held in tension by at least one of: attachment to the first rigid frame portion and attachment to the second rigid frame portion, and attachment to the first rigid portion and a weight of the loose solid sorbent; and
at least one of:
flowing air through the sorbent compartment, the loose solid sorbent adsorbing a material from the air; and
applying thermal energy to the sorbent compartment to cause a heat exchange process between the solid sorbent and the thermal energy source to remove the adsorbed material from the loose solid sorbent.

14. The method of claim 13, wherein the flexible sheet is a mesh or a perforated sheet of a flexible material, or a perforated sheet having a thickness selected so that the perforation sheet is caused to be flexible.

15. The method of claim 13, further comprising adjusting an amount of the tension by a tensioning device configured to engage at least one of the first rigid frame portion and the second rigid frame portion.

16. The method of claim 15, wherein the first rigid frame portion and the second rigid frame portion hold the porous structure in tension to form a stiff wall that holds the shape of the sorbent compartment without any additional components, the additional components including a component internal to the sorbent compartment, a component between multiple sorbent compartments, and a component attached to the porous structure between the first frame portion and the second frame portion.

17. The method of claim 16, wherein the porous structure is formed as a porous sheet defining a wall of the compartment, the porous sheet forming a surface orthogonal to a direction of airflow through the device.

18. The method of claim 16, wherein the porous structure is a sleeve having an opening attached to the first rigid frame portion, and an end attached to the second rigid frame portion to hold the sleeve in tension.

19. The method of claim 18, wherein the end attached to the second rigid frame portion is open.

20. The method of claim 13, wherein the porous structure is a flexible sleeve forming a wall of the sorbent compartment.
